(19) United States
(12) Patent Application Publication
(10) Pub. No.: US 2015/0360623 A1
(43) Pub. Date: Dec. 17, 2015

(54) VEHICLE INTERIOR ZERO GAP SYSTEM AND METHOD

(71) Applicant: JOHNSON CONTROLS TECHNOLOGY COMPANY, Holland, MI (US)

(72) Inventors: Danny B. Larsen, Holland, MI (US); Chris J. Harmelink, Grandville, MI (US); Tyler Newkirk, Grand Rapids, MI (US); Heather R. Springer, West Olive, MI (US); David J. McCarthy, Holland, MI (US); Glenn A. Cowelchuk, Holland, MI (US); Nicholas T. Moelker, Allendale, MI (US)

(21) Appl. No.: 14/760,335

(22) PCT Filed: Jan. 10, 2014
(86) PCT No.: PCT/US2014/011104

§ 371 Date: Jul. 10, 2015

Related U.S. Application Data
(60) Provisional application No. 61/751,673, filed on Jan. 11, 2013.

(51) Int. Cl. B60R 13/02

(52) U.S. Cl. CPC B60R 13/02; B60R 2013/0293

(57) ABSTRACT

A vehicle interior comprises a zero-gap joint formed by a first component that holds a sheet-like flexible material that is supported by supports, and a protrusion of a second component that contacts and deforms the material. The material may comprise a fabric or coated material that is coordinated with the design of the interior. The joint may be formed between components that move relative to one another during normal operation of the vehicle, such as between an instrument panel and a vehicle door panel.

### BACKGROUND

The invention relates generally to motor vehicles, and more particularly, to arrangements at joints between vehicle interior components.

A number of regions exist within vehicle interiors where two or more components come together or should closely approach one another in order to provide an attractive appearance. For example, where ends of a dash board approach door panels, a small space or gap is generally left, and kept fairly small such that the overall look of the transition is appealing. A number of other regions or transitions exist where similar gaps are left between the interior components.

While the vehicle occupant may appreciate such fit and finish, from design and manufacturing standpoints, they are often difficult to obtain and maintain, and generally present engineering challenges. Such issues as manufacturing tolerances, tolerance stacking, individual component and component assembly quality and craftsmanship can result in significant engineering and manufacturing investment, particularly in launch and ongoing quality maintenance. Such challenges are particularly difficult where one or more of the interior components moves with respect to another. For example, a door panel will frequently be moved away from the end of a dash board or instrument panel as the door is opened. Movement of the door and panel when door is reclosed often results in some degree of “overslam”, such that any gap left between the door panel and the dash board or instrument panel must accommodate this temporary relative position without wearing or destroying either component.

There is a need in the art, therefore, for improved techniques for the design and manufacture of vehicle components and component assemblies that can reduce the need for high-tolerance fit-up, while maintaining cost-effective structures that are versatile over model years and platforms, and that present pleasing appearances in reliable installations.

### BRIEF DESCRIPTION OF THE INVENTION

The present disclosure sets forth certain vehicle interior solutions designed to address such needs. In accordance with certain embodiments, a vehicle interior comprises a first component comprising a support structure and a sheet-like flexible material disposed on the support structure and held taut between supports. A second component comprises a protrusion that contacts and deforms the sheet-like flexible material from a relaxed configuration to a deformed configuration to create a zero-gap joint between the first and second components.

In accordance with other embodiments, a vehicle interior comprises first and second interior components, the first component being movable with respect to the second component during normal operation of the vehicle. The first component comprises a support structure and a sheet-like flexible material disposed on the support structure and held taut between supports. The second component comprises a protrusion that contacts and deforms the sheet-like flexible material from a relaxed configuration assumed by the material when the first component is moved away from the second component to a deformed configuration when the first component is moved towards the second component to create a zero-gap joint between the first and second components.

The disclosure also provides a method for making a vehicle interior, comprising supporting a sheet-like flexible material over a support structure of a first component to hold the sheet-like flexible material taut between supports. A protrusion is formed on a second component that contacts and deforms the sheet-like flexible material from a relaxed configuration assumed by the material when the first component is moved away from the second component to a deformed configuration when the first component is moved towards the second component to create a zero-gap joint between the first and second components.

### DRAWINGS

FIG. 1 is a perspective view of an exemplary vehicle interior that may include a zero gap joint between interior components;

FIG. 2 is a partial cross-sectional view of a portion of such a joint as provided in the prior art;

FIG. 3 is a similar cross-sectional view of a similar joint, along line 3-3 of FIG. 1, illustrating an exemplary technique for forming a zero-gap joint in accordance with the present disclosure;

FIG. 4 is a diagrammatical representation of an alternative embodiment for a flexible zero gap joint;

FIG. 5 is a diagrammatical representation of a further alternative embodiment for a flexible zero gap joint;

FIGS. 6 and 7 are representations of a further alternative embodiment of a flexible zero gap joint;

FIG. 8 is a diagrammatical representation of a further alternative embodiment for a flexible zero gap joint;

FIG. 9 is a diagrammatical representation of a further alternative embodiment for a flexible zero gap joint; and

FIG. 10 is a diagrammatical representation of a further alternative embodiment for a flexible zero gap joint.

### DETAILED DESCRIPTION

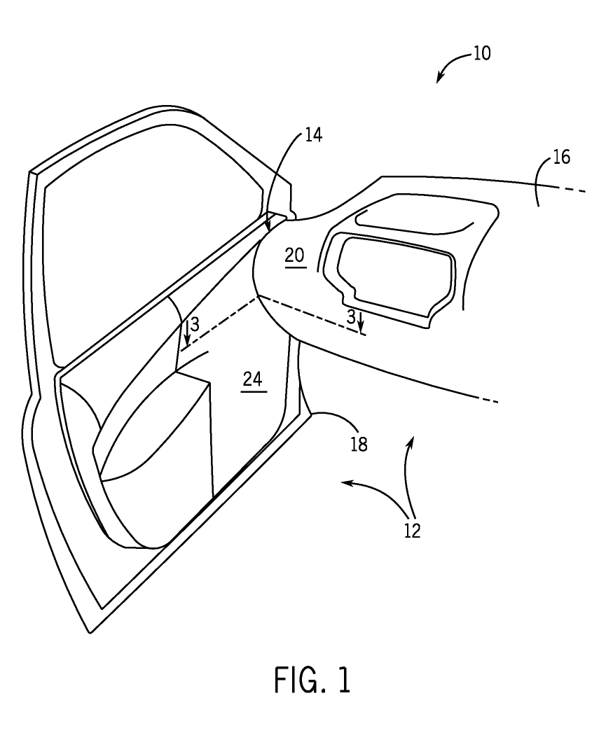

FIG. 1 is a perspective view of an exemplary vehicle interior 10, such as in a car, truck, or any other vehicle. Two or more interior components 12 will fit nicely with respect to one another, and are typically fitted either prior to final assembly of the vehicle interior, or during the assembly of the various components or sub-assemblies. In general, a joint 14 will be defined between the components, and this joint may be “dynamic” in the sense that one or more of the components may need to move with respect to at least one other component during regular use of the vehicle. The interior components, in the illustration of FIG. 1, include a dash board or instrument panel 16 and a door 18. The joint, in this example, is formed between an end 20 of the instrument panel (forming a zero-gap joint 22) and an interior panel 24 of the door 18.

As will be appreciated by those skilled in the art, where vehicle interior components meet, one or both of the components must be created, manufactured, and assembled so as to maintain the desired fit between them. Moreover, where components, such as instrument panels have multiple parts, each of these must be made and assembled with an eye to respecting the ultimate fit and finish of the composite structure. Tolerance stacking of such sub-assemblies may make maintaining of desired gaps between the components difficult. Moreover, where one or more of the components moves during normal use, maintaining such gaps is even more difficult. This is particularly true of doors and similar components, where normal movement and over-movement, such as over-slam will reduce or even eliminate the desired gap from time to time.

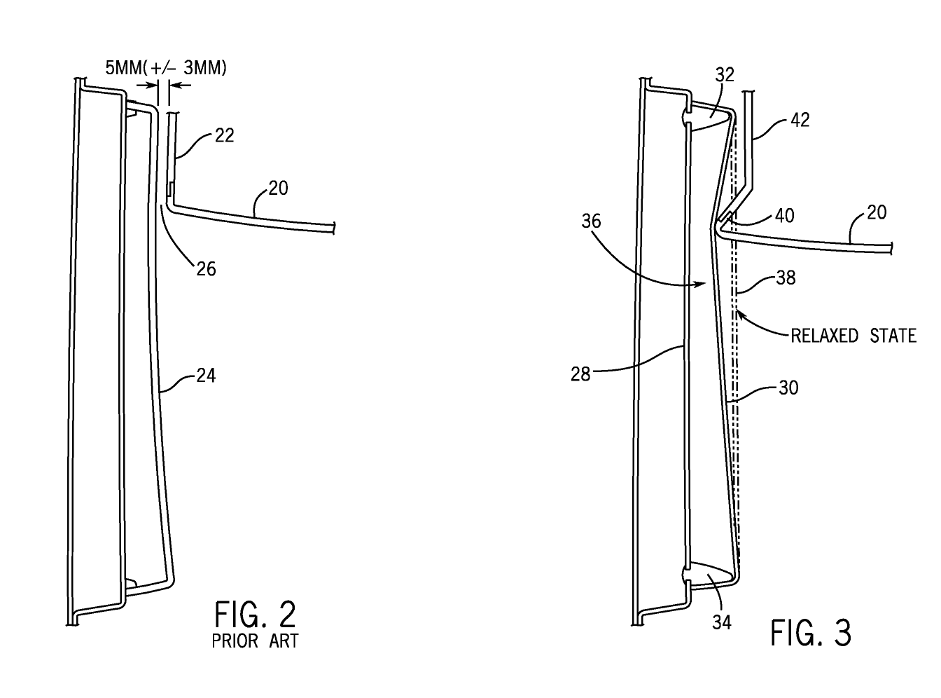

FIG. 2 illustrates a typical fit-up of an instrument panel or dash board end 20 and an interior panel 24 of a door in accordance with the prior art. The instrument panel end 20 will typically be terminated by a plastic or covered end extension 22 that continues forward to locations where the instrument panel is mounted to the support structures (not shown). The interior panel 24 of the door is typically a plastic or covered panel that is clipped or otherwise affixed to the metal support structure that forms the door. A gap 26 is left between the extension 22 and the interior panel 24 to accommodate movement of the door or the instrument panel, or both, during normal operation of the vehicle. This gap may be closed significantly, for example, when the door is closed, resulting from the tendency of the door to move inwardly slightly beyond its normal position (movement that is allowed by the seal around the door). The gap, the dimensions of which are generally reduced to the extent possible by control of the dash and door components, exists at all times during use of the vehicle, however.

FIG. 3 illustrates an exemplary configuration for a zero-gap joint between vehicle interior components. In this embodiment, the door panel comprises a support structure 28 and at least one flexible element 30 held on the support structure. The interior door panel is thus composed at least partially of supports 32 and 34 on which the flexible panel or sheet material 30 is disposed. The supports may be continuous structures that form a rim or frame over which the sheet material is stretched, or separate structures may be formed. Moreover, the supports may be part of an interior element of the door itself, or as in the illustrated embodiment, one or more separate components that are assembled on the door. The sheet material may be secured to these supports in any suitable manner, such as by tucking it beneath or around the supports, clipping it to the supports, gluing or otherwise affixing it to a surface of the supports, and so forth. The flexible or sheet material may comprise any suitable material, such as a fabric, an elastomeric sheet, a woven or non-woven sheet, and so forth. Where desired, this material may be colored, covered, or treated to provide a desired appearance, consistent with the design concepts of the overall interior. While in some embodiments the flexible material may be a foam, solid or semi-solid, or another non-sheet structure, it is advantageously stretched or maintained in a condition that will not take a “set” so as to gradually form a gap that is not closed when the components are brought together. Where the material is flexible, and suspended between the supports, it may be kept taut during times when the components are relatively close to one another owing to the inherent properties of the material.

It should be noted that, while reference is made to a sheet-like material that may be in the form of a thin fabric or the like, other embodiments covered by this disclosure may include sheet-like materials that comprise compressible solids or semi-solids. Moreover, the material may comprise a covering, which in some cases may be a decorative covering. These may include, for example, integral skin-like coatings or coverings.

In the illustrated embodiment, at least one region of the instrument panel or dash board 20 is designed to contact and deform the material, as indicated by reference numeral 36. This deformed configuration may indent or stretch the material from a relaxed configuration, as indicated by reference numeral 38. In the illustrated embodiment, a protrusion 40 of the instrument panel forms a smooth corner that contacts and deforms the material 30. To allow for such deformation, the protrusion 40 is followed by a recess 42 into which the support 32 at least partially moves when the components are brought together.

In the case of a door and instrument panel joint, then, when the door is opened, the material 30 will generally assume its relaxed configuration 38. However, when the door is closed, the protrusion 40 will contact and deform the material 30. Some degree of temporary movement of the door, such as due to overslam, is allowed by the elasticity of the material 30, and the overlap between the protrusion 40 and the support 32, without allowing for a gap to develop between the material 30 and the protrusion 40. The components thus remain in this “zero-gap” state during normal operation (i.e., when the door remains closed).

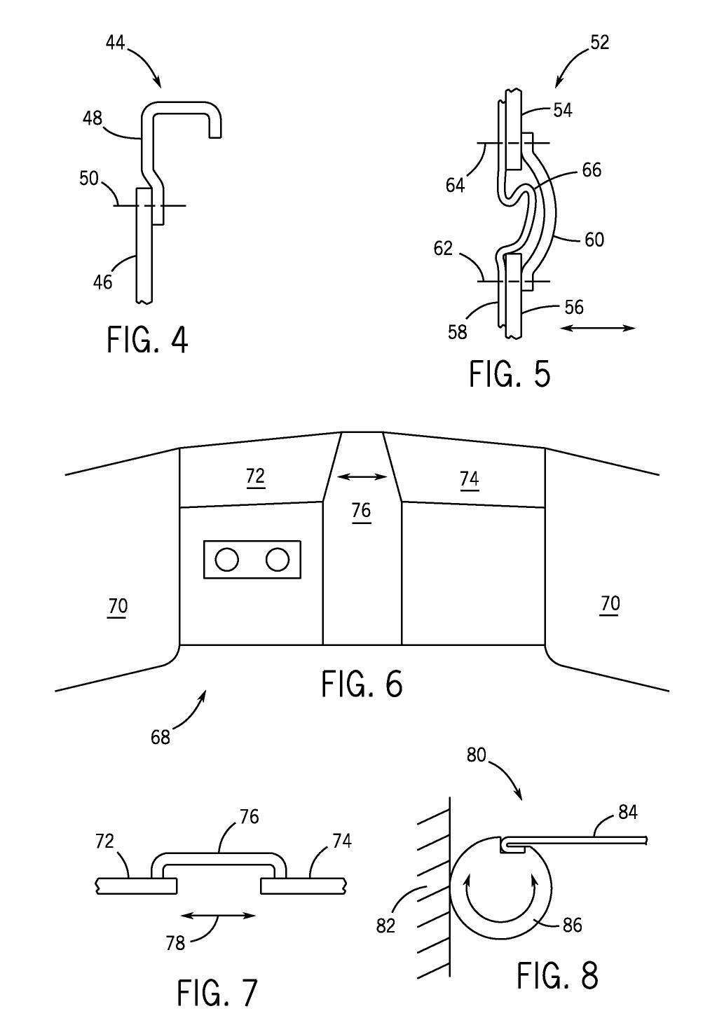

FIG. 4 illustrates an alternative embodiment for a zero gap joint 44 as might be used in a vehicle interior, such as between components. In this joint 44, a panel 46 is jointed to a flexible material 48 by means of a stitch 50 or other mechanical joint (e.g., adhesive, welding, etc., or a combination of such techniques). Movement of the panel 46 is permitted while eliminating any gap between the panel and any nearby or adjoining components by movement of the flexible material 48.

FIG. 5 is diagrammatical representation of a further alternative embodiment of a zero gap joint 52. In this embodiment, two interior panels or components 52 and 54 are positioned adjacent to one another. A flexible material 58 is placed on one side of the joint, while another flexible material or cover 60 is placed on the opposite side. Either or both materials may be flexible, elastic, or otherwise able to bend, fold, stretch, and so forth to permit movement of the two components with respect to one another. In the illustrated approach, the components and the materials are joined by stitching, as indicated by reference numerals 62 and 64, although other techniques may be used, as summarized above.

FIGS. 6 and 7 illustrate a further alternative embodiment for a zero gap joint 68. In this approach, illustrated in the context of vehicle doors 70, and two elements of an instrument panel, 72 and 74, one or more of the adjacent components is permitted to “float” somewhat, and may be positioned adjacent to the doors during assembly of the vehicle. Thereafter, the components may to move towards and away from one another. In the illustrated approach, the instrument panel components may move, typically only during initial installation, and these are joined by an element 76 which hides any movement of the components, and which in some embodiments may be rigid, semi-rigid, flexible and/or elastic. As shown in the view of FIG. 7, this element closes a gap between the components 72 and 74, while permitting the desired movement, as indicated by arrow 78.

FIG. 8 illustrates a further alternative embodiment of a zero gap joint 80. In this embodiment, a component 82 is disposed adjacent to another element 84, such as a flexible, elastic or sheet-like material. A gap between the component 82 and the element 84 is closed by a torsion spring assembly 86, which is secured near the component 82, and to the element 84, allowing the element 84 to move outwardly and inwardly under the tension imposed by the spring assembly. The element 84 is thereby effectively “reeling in” and “paying out” the element 84 while maintaining the gap closed.

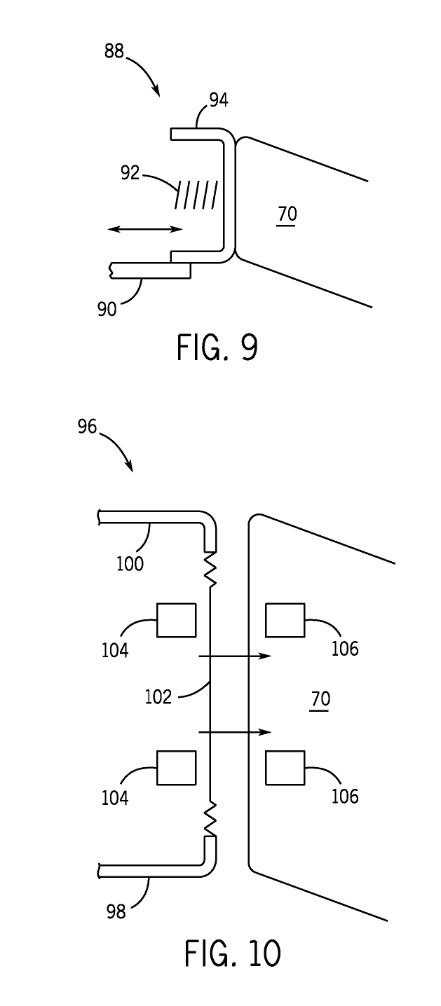

FIG. 9 illustrates a further alternative for a zero gap joint 88. In this embodiment, a first component 90, such as an instrument panel component, is positioned next to another component, such as a door 70. A spring arrangement 92 urges an intermediate component 94 towards the door 70, closing a gap that would otherwise be created between the instrument panel component and the door component. The size and configuration of the intermediate component 94, the placement of the spring arrangement, the number of spring arrangements, and so forth, may be specified based upon the shape, size, and placement of the panel component and the door, as well as based upon the spacing or gap between the two and the degree of movement of the door.

FIG. 10 illustrates a further alternative embodiment for a zero gap joint 96. In this embodiment, two panels 98 and 100 are positioned adjacent to another component, such as a door 70. A movable element 102 extends between the panels 98 and 100, and may itself be flexible, or may have somewhat flexible sections or regions built into it, or affixed to it. This arrangement of the element 102 allows it to move towards and away from the door as the door is opened and closed. Magnets 104 are disposed on one side of the element 102 (e.g., within an instrument panel), while other magnets 106 are disposed on an opposite side (e.g., within the door). It will be apparent that both elements 104 and 106 may be magnets, or only one of these may be magnets, with the other comprising a material that is attracted by a magnet (e.g., a ferromagnetic material). This embodiment allows for the gap between the instrument panel and the door to be maintained closed by the attraction of the magnetic components, which causes flexure or movement of the element 102.

As noted above, while reference is made in this disclosure to joints between a door and an instrument panel, this should be understood to constitute only one possible application for the zero-gap constructions disclosed. In general, this technique differs from conventional gaskets and the like insomuch as the sheet-like material will most often be at least partially visible when in normal use, and therefore will typically be selected to match or in coordination with other interior components and the design or “look” of the interior. Other examples of applications for the present zero-gap constructions include interfaces between floor consoles and instrument panels, as well as any other area where fit and finish are of concern, particularly to meet manufacturing challenges and aesthetic goals. Similarly, rather than the construction where a door panel is flexible and an instrument panel is rigid (i.e., defines the protrusion that interfaces with the flexible material), the opposite construction may be envisaged, where the instrument panel has a flexible interface surface and the door panel is rigid or semi-rigid. Similar constructions may comprise two mutually interfacing semi-flexible materials that contact and deform one another to form the desired zero-gap joint. Finally, it should be appreciated that the zero-gap joint is not limited to use between movable and stationary parts, but could be used between any two or more components to achieve excellent fit and finish at the time of installation.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A vehicle interior comprising:
a first component comprising a support structure and a sheet-like flexible material disposed on the support structure and held taut between supports; and
a second component comprising a protrusion that contacts and deforms the sheet-like flexible material from a relaxed configuration to a deformed configuration to create a zero-gap joint between the first and second components;
wherein the first and second components cooperate to permit deformation of at least one of the first and second components or the sheet-like flexible material during overslam of a vehicle door and thereafter to return to a non-overslam condition.

2. The vehicle interior of claim 1, wherein the first component is moveable with respect to the second component during normal use of the vehicle.

3. The vehicle interior of claim 2, wherein the first component comprises a door panel.

4. The vehicle interior of claim 3, wherein the second component comprises an instrument panel or dash board.

5. The vehicle interior of claim 1, wherein at least one of the supports overlaps with the protrusion when the first and second components are brought together to permit deformation of the sheet-like flexible material.

6. The vehicle interior of claim 1, wherein the sheet-like flexible material comprises a fabric.

7. The vehicle interior of claim 1, wherein the sheet-like flexible material comprises a decorative material coordinated with a design appearance of the vehicle interior.

8. The vehicle interior of claim 1, wherein the sheet-like flexible material us generally unsupported between the supports.

9. A vehicle interior comprising:
first and second interior components, the first component being movable with respect to the second component during normal operation of the vehicle;
wherein the first component comprises a support structure and a sheet-like flexible material disposed on the support structure and held taut between supports; and
wherein the second component comprises a protrusion that contacts and deforms the sheet-like flexible material from a relaxed configuration assumed by the material when the first component is moved away from the second component to a deformed configuration when the first component is moved towards the second component to create a zero-gap joint between the first and second components;
and wherein at least one of the first and second components comprises a magnet and the other of the first and second components comprises a material that interacts with the magnet to allow deformation of the sheet-like flexible material.

10. The vehicle interior of claim 9, wherein the first component comprises a door panel.

11. The vehicle interior of claim 10, wherein the second component comprises an instrument panel or dash board.

12. The vehicle interior of claim 9, wherein at least one of the supports overlaps with the protrusion when the first and second components are brought together to permit deformation of the sheet-like flexible material.

13. The vehicle interior of claim 9, wherein the sheet-like flexible material comprises a fabric.

14. The vehicle interior of claim 9, wherein the sheet-like flexible material comprises a decorative material coordinated with a design appearance of the vehicle interior.

15. The vehicle interior of claim 9, wherein the sheet-like flexible material us generally unsupported between the supports.

16. A method for making a vehicle interior, comprising:
supporting a sheet-like flexible material over a support structure of a first component to hold the sheet-like flexible material taut between supports; and
forming a protrusion on a second component that contacts and deforms the sheet-like flexible material from a relaxed configuration assumed by the material when the first component is moved away from the second component to a deformed configuration when the first component is moved towards the second component to create a zero-gap joint between the first and second components;
wherein the first and second components cooperate to permit deformation of at least one of the first and second components or the sheet-like flexible material during overslam of a vehicle door and thereafter to return to a non-overslam condition.

17. The method of claim 16, wherein the first component comprises a door panel.

18. The method of claim 17, wherein the second component comprises an instrument panel or dash board.

19. The method of claim 16, wherein at least one of the supports overlaps with the protrusion when the first and second components are brought together to permit deformation of the sheet-like flexible material.

20. The method of claim 16, wherein the sheet-like flexible material comprises a fabric.
